(19) United States
(12) Patent Application Publication
(10) Pub. No.: US 2016/0321835 A1
(43) Pub. Date: Nov. 3, 2016

(54) IMAGE PROCESSING DEVICE, IMAGE PROCESSING METHOD, AND DISPLAY DEVICE

(71) Applicant: Panasonic Intellectual Property Management Co., Ltd., Osaka (JP)

(72) Inventor: TADASHI YOSHIDA, Osaka (JP)

(21) Appl. No.: 15/089,418

(22) Filed: Apr. 1, 2016

(30) Foreign Application Priority Data
Apr. 28, 2015 (JP) 2015-092391

(51) Int. Cl. G06T 15/00; G06T 15/04; G06T 1/60

(52) U.S. Cl. CPC G06T 15/005; G06T 1/60; G06T 15/04; G06T 2200/28

(57) ABSTRACT

An image processing device includes a pixel shader for deciding a color of each of a plurality of pixels forming a diagram that is defined by three or more first coordinate system vertices on a two-dimensional picture, and a determinator for determining whether or not shading processing on a per block basis is able to be performed, for a block including some of the plurality of pixels. The pixel shader decides, in a case where the determinator determines that the shading processing on a per block basis is able to be performed, a representative color of the block by performing the shading processing on a per block basis on the block, and decides, in a case where the determinator determines that the shading processing on a per block basis is not able to be performed, a color of each of the plurality of pixels by performing shading processing on a per pixel basis on the each of the plurality of pixels.

### BACKGROUND

1. Field of the Disclosure

The present disclosure relates to an image processing device, an image processing method, and a display device.

2. Background Art

Unexamined Japanese Patent Publication No. 2006-318404 (PTL 1) discloses a diagram drawing device. A process for generating a two-dimensional picture from three-dimensional shape data defined by one or a plurality of polygons generally includes vertex shader processing of transforming three-dimensional coordinates of the vertices of a polygon into coordinates on a two-dimensional picture, interpolation processing of generating pixel parameters (two-dimensional coordinates, information for deciding the color, the degree of transparency, etc.) of a plurality of pixels forming the polygon, and pixel shader processing of deciding the color of each of the plurality of pixels.

### SUMMARY

The present disclosure provides an image processing device, an image processing method, and a display device which are capable of reducing the load of processing.

An image processing device according to the present disclosure is an image processing device including a pixel shader for deciding a color of each of a plurality of pixels forming a diagram that is defined by three or more first coordinate system vertices on a two-dimensional picture. The image processing device includes a determinator for determining whether or not shading processing on a per block basis is able to be performed, for a block including some of the plurality of pixels. The pixel shader decides, in a case where the determinator determines that the shading processing on a per block basis is able to be performed, a representative color of the block by performing the shading processing on a per block basis on the block. The pixel shader decides, in a case where the determinator determines that the shading processing on a per block basis is not able to be performed, a color of each of the plurality of pixels by performing shading processing on a per pixel basis on the each of the plurality of pixels.

The image processing device, the image processing method, and the display device according to the present disclosure are capable of reducing the load of processing.

### BRIEF DESCRIPTION OF DRAWINGS

FIG. 1 is a block diagram showing an example of configuration of an image processing device according to a comparative example;

FIG. 2 is a flow chart showing an example of a processing procedure of an image processing method according to the comparative example;

FIG. 3 is a diagram showing a relationship between a point-of-sight position and a polygon according to the comparative example and an exemplary embodiment;

FIG. 4 is a diagram, according to the comparative example, showing an example of a triangle shown in FIG. 3 on a two-dimensional picture when the triangle is seen from the point-of-sight position;

FIG. 5 is a block diagram showing an example of configuration of an image processing device according to a first exemplary embodiment;

FIG. 6 is a flow chart showing an example of a processing procedure of an image processing method according to the first exemplary embodiment;

FIG. 7 is a diagram, according to the first exemplary embodiment, showing an example of a triangle shown in FIG. 3 on a two-dimensional picture when the triangle is seen from the point-of-sight position;

FIG. 8 is a diagram showing an example of a unit of expansion processing according to the first exemplary embodiment;

FIG. 9 is a diagram showing an example of a reference pixel in bilinear reference according to the first exemplary embodiment;

FIG. 10 is a diagram, according to the first exemplary embodiment, showing examples of two-dimensional pictures where a threshold value used for determination of a color difference is changed;

FIG. 11 is a diagram, according to the first exemplary embodiment, for illustrating determination of whether a polygon edge is included or not;

FIG. 12A is a diagram for illustrating an example of enlargement processing according to the first exemplary embodiment;

FIG. 12B is a diagram for illustrating the example of the enlargement processing according to the first exemplary embodiment;

FIG. 13 is a diagram showing an example of a number of times of shading processing according to the first exemplary embodiment;

FIG. 14A is a diagram for illustrating a difference between a two-dimensional picture generated by using the image processing device of the first exemplary embodiment and a two-dimensional picture generated by using the image processing device of the comparative example;

FIG. 14B is a diagram for illustrating the difference between the two-dimensional picture generated by using the image processing device of the first exemplary embodiment and the two-dimensional picture generated by using the image processing device of the comparative example;

FIG. 15A is a diagram for illustrating an example of enlargement processing according to a second modified example;

FIG. 15B is a diagram for illustrating an example of the enlargement processing according to the second modified example;

FIG. 16 is a diagram showing an example of a number of times of shading processing according to the second modified example; and

FIG. 17 is a diagram showing an example of a display device provided with an image processing device according to the first exemplary embodiment and the second modified example.

### DETAILED DESCRIPTION

### Details of Problem

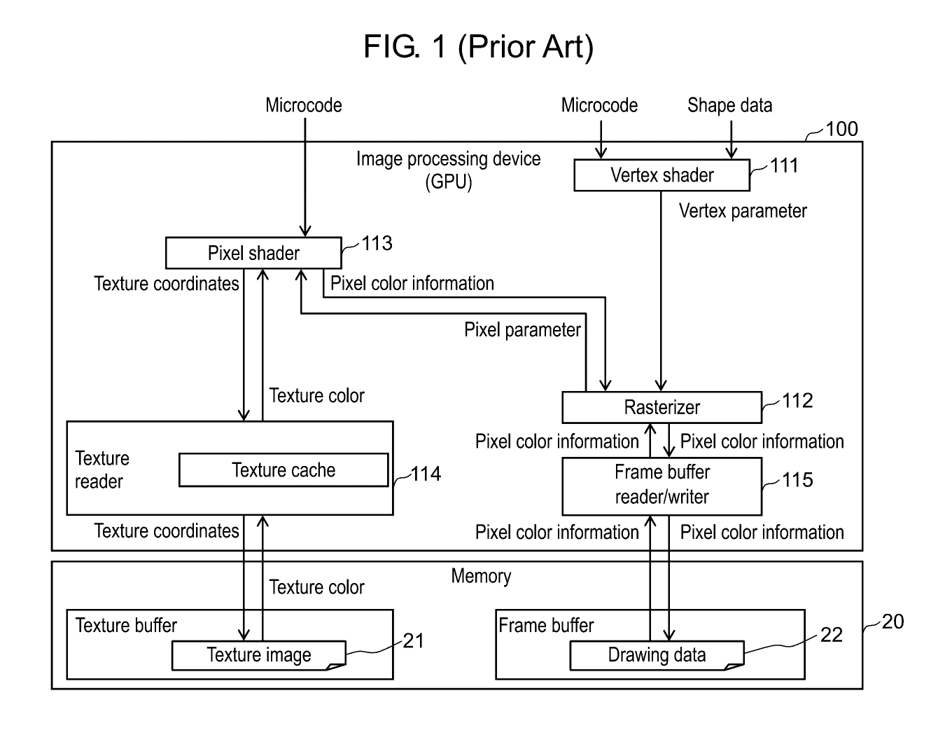

FIG. 1 is a block diagram showing an example of configuration of an image processing device according to a comparative example.

Image processing device 100 shown in FIG. 1 is a device for generating a two-dimensional picture which is a three-dimensional shape seen from a predetermined point of sight.

As shown in FIG. 1, image processing device 100 includes vertex shader 111, rasterizer 112, pixel shader 113, texture reader 114, and frame buffer reader/writer 115. Also, image processing device 100 is configured to be capable of performing reading processing and writing processing on memory 20.

Memory 20 is a memory for storing data used for generation of a two-dimensional picture, and a generated two-dimensional picture (drawing data). Memory 20 is configured by a DRAM (Dynamic Random Access Memory) or the like. Data used for generation of a two-dimensional picture includes a texture image which is used for deciding the color on the two-dimensional picture, for example. A memory area for storing a texture image will be referred to as a texture buffer, and a memory area for storing drawing data will be referred to as a frame buffer.

Vertex shader 111 is an engine for transforming three-dimensional coordinates of three or more second coordinate system vertices defining a three-dimensional shape into two-dimensional coordinates of three or more first coordinate system vertices on a two-dimensional picture to be eventually drawn. Vertex shader 111 outputs, to rasterizer 112, vertex parameters including the two-dimensional coordinates of each of the three or more first coordinate system vertices. Vertex shader 111 may also perform a lighting process on a per vertex basis, in addition to the coordinate transformation. Additionally, the coordinates of a first coordinate system vertex after transformation by vertex shader 111 are two-dimensional coordinates, but depending on the intended use, the coordinates may be in dimensions equal to or higher than two (for example, three-dimensional coordinates (x, y, z), four-dimensional coordinates (x, y, z, w), or the like).

Rasterizer 112 performs, by using the vertex parameters, interpolation processing of generating pixel parameters for each of a plurality of pixels forming a diagram on the two-dimensional picture defined by the three or more first coordinate system vertices. The pixel parameters include coordinates on the two-dimensional picture, information for deciding the color, the degree of transparency, and the like. Rasterizer 112 outputs the pixel parameters to pixel shader 113.

Moreover, rasterizer 112 acquires pixel, color information, which is information indicating the color of each of the plurality of pixels, from pixel shader 113. Rasterizer 112 performs semitransparent synthesis processing by using the acquired pixel color information, and outputs the pixel color information after the semitransparent synthesis processing to frame buffer reader/writer 115. Frame buffer reader/writer 115 stores the pixel color information after the semitransparent synthesis processing in the frame buffer of memory 20.

Pixel shader 113 is an engine for deciding the color of each of the plurality of pixels by using the pixel parameters output from rasterizer 112. The decided color of each of the plurality of pixels is the color seen from the point-of-sight position. Pixel shader 113 performs shading processing based on a color value which is obtained by referring to a texture image or a color value which is obtained from the pixel parameters, to determine the color that is seen from the point-of-sight position. The color seen from the point-of-sight position may thus be obtained for each of the plurality of pixels.

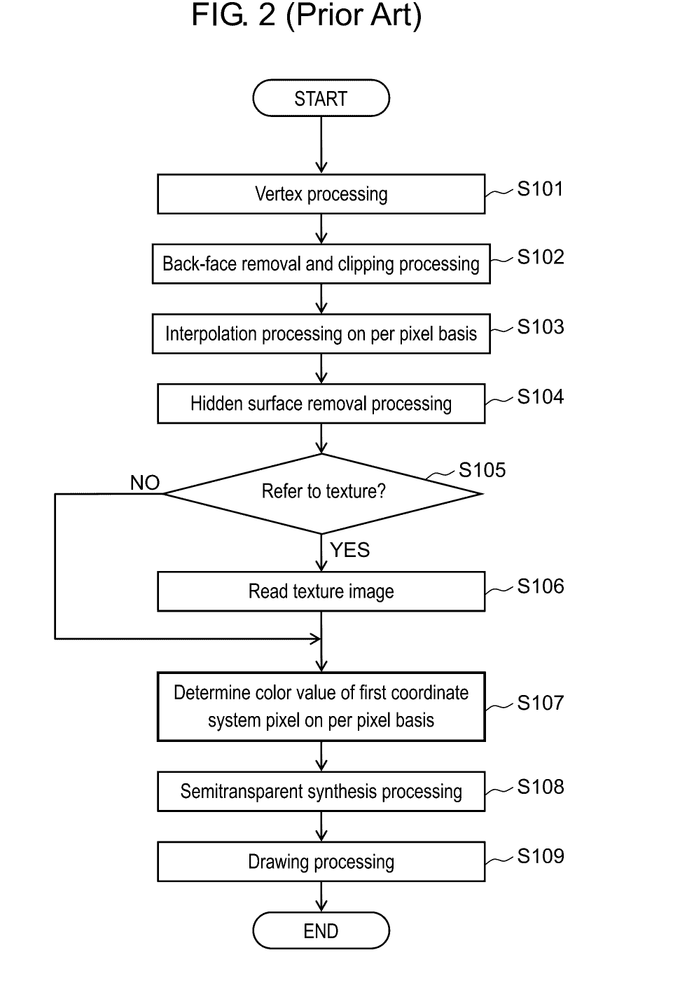

FIG. 2 is a flow chart showing an example of a processing procedure of an image processing method according to the comparative example.

FIG. 2 shows a processing procedure of a process for generating a two-dimensional picture from three-dimensional shape data.

Vertex shader 111 performs vertex processing by using the three-dimensional shape data (step S101).

Generally, the three-dimensional shape data is data representing a predetermined three-dimensional body by one polygon or a combination of a plurality of polygons. A polygon is a triangle, for example, but the polygon may be a rectangle, a pentagon, or the like. In the vertex processing, vertex shader 111 calculates, for the one polygon or each of the plurality of polygons, two-dimensional coordinates of first coordinate system vertices, which are points on a two-dimensional picture, corresponding to the second coordinate system vertices of the polygon, by using the three-dimensional coordinates of the three of more second coordinate system vertices forming the polygon and (if necessary,) a coordinate transformation matrix for transforming three-dimensional shape data into coordinates on the two-dimensional picture seen from point-of-sight position POS. Vertex shader 111 outputs, to rasterizer 112, vertex parameters including the coordinates of the first coordinate system vertices calculated.

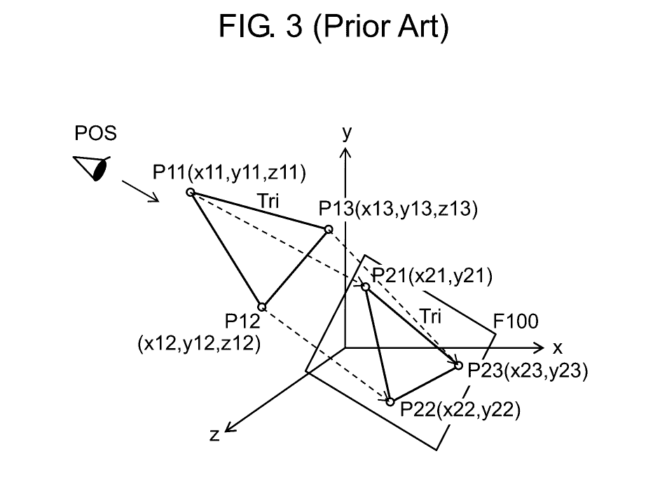

FIG. 3 is a diagram showing a relationship between a point-of-sight position and a polygon according to the comparative example.

In FIG. 3, coordinates of second coordinate system vertices P11 to P13 of triangle Tri are stored as shape data. Vertex shader 111 transforms three-dimensional coordinates (x11, y11, z11) of second coordinate system vertex P11, three-dimensional coordinates (x12, y12, z12) of second coordinate system vertex P12, and three-dimensional coordinates (x13, y13, z13) of second coordinate system vertex P13 into coordinates on two-dimensional picture F100 seen from point-of-sight position POS.

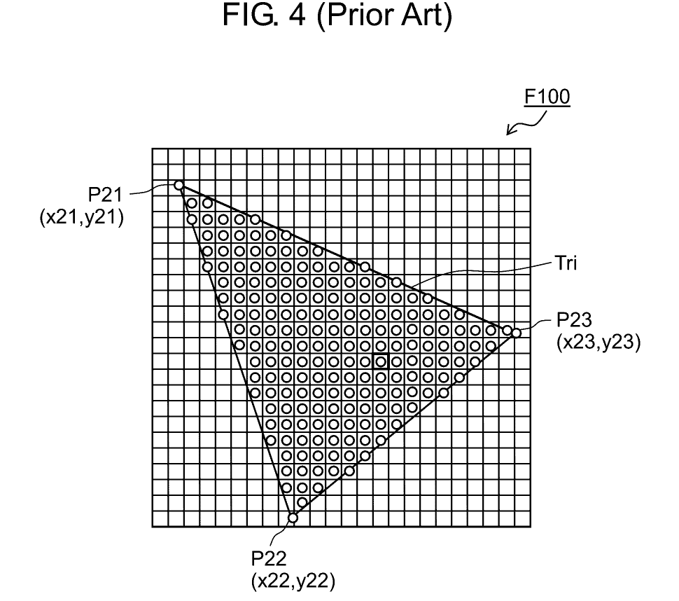

FIG. 4 is a diagram showing an example of triangle Tri on two-dimensional picture F100 when triangle Tri in FIG. 3 is seen from point-of-sight position POS.

First coordinate system vertex P21 is a point, on the two-dimensional picture, corresponding to second coordinate system vertex P11. The two-dimensional coordinates of first coordinate system vertex P21 are (x21, y21). First coordinate system vertex P22 is a point, on the two-dimensional picture, corresponding to second coordinate system vertex P12. The two-dimensional coordinates of first coordinate system vertex P22 are (x22, y22). First coordinate system vertex P23 is a point, on the two-dimensional picture, corresponding to second coordinate system vertex P13. The two-dimensional coordinates of first coordinate system vertex P23 are (x23, y23).

After the vertex processing, rasterizer 112 performs back-face removal processing and clipping processing (step S102).

The back-face removal processing is processing of removing a polygon which is at a position that cannot be seen from the point-of-sight position. The clipping processing is processing of identifying, for a polygon which is at a position at which a partial region is not seen from the point-of-sight position, a pixel which is at a position that can be seen from the point-of-sight position.

Next, rasterizer 112 performs interpolation processing on a per pixel basis (step S103).

In the interpolation processing, pixel parameters are obtained for each of a plurality of pixels forming each of polygons which can be partially or entirely seen from the point-of-sight position, among polygons forming a predetermined three-dimensional body. The pixel parameters include two-dimensional coordinates, information for deciding the color, the degree of transparency, and the like. The information for deciding the color includes position coordinates of a reference pixel (hereinafter referred to as “texture coordinates”) in a case where a texture image is used, or a color value.

Furthermore, rasterizer 112 performs hidden surface removal processing of removing pixel parameters of a hidden part (a part not seen from the point-of-sight position) (step S104).

After the hidden surface removal processing, rasterizer 112 outputs the pixel parameters to pixel shader 113.

In a case where reference to a texture image is indicated by a microcode (YES in step S105), pixel shader 113 reads a texture image via texture reader 114 (step S106).

Pixel shader 113 performs shading processing on a per pixel basis (step S107).

Specifically, pixel shader 113 decides the color of each of a plurality of pixels by performing arithmetic processing indicated by a microcode. In a case where the texture image is to be referred to in the shading processing, pixel shader 113 acquires, for each of the plurality of pixels, the color value of a reference image of the texture image indicated by texture coordinates. Pixel shader 113 outputs, to rasterizer 112, pixel color information, which is information indicating the decided color value of each of the plurality of pixels.

Rasterizer 112 performs semitransparent synthesis processing by using the degree of transparency included in the pixel parameters, and generates drawing data (step S108).

Then, rasterizer 112 performs drawing processing of writing the drawing data generated in step S108 in the frame buffer of memory 20 by using frame buffer reader/writer 115 (step S109).

In recent years, the definition of display devices such as liquid crystal displays, organic electroluminescence (EL) displays, or the like is more and more increased. Accordingly, the number of pixels for forming a two-dimensional picture to be displayed by such a display device is significantly increased.

Pixel shader 113 performs relatively complex processing indicated by a microcode, and high-load processing such as texture reference, or the like, and thus its processing time is relatively long. Accordingly, the processing time necessary to generate a two-dimensional picture by image processing device 100 depends on a number of times of activation of pixel shader 113 described above.

In image processing device 100 of the comparative example, pixel shader 113 needs to be activated for each first pixel, and thus the number of times of activation of the pixel shader is increased as the number of a plurality of pixels is increased.

As described above, in recent years, the definition of a display device is more and more increased, and thus the number of times of activation of pixel shader 113 of image processing device 100 per one frame is dramatically increased, and there is a problem that the processing time is also dramatically increased.

Hereinafter, exemplary embodiments will be described in detail with reference to the drawings as appropriate. However, unnecessarily detailed description may be omitted. For example, detailed description of already well-known matters and repeated description of substantially the same structure may be omitted. All of such omissions are intended to facilitate understanding by those skilled in the art by preventing the following description from becoming unnecessarily redundant.

Moreover, the appended drawings and the following description are provided for those skilled in the art to fully understand the present disclosure, and do not intend to limit the subject described in the claims.

### First Exemplary Embodiment

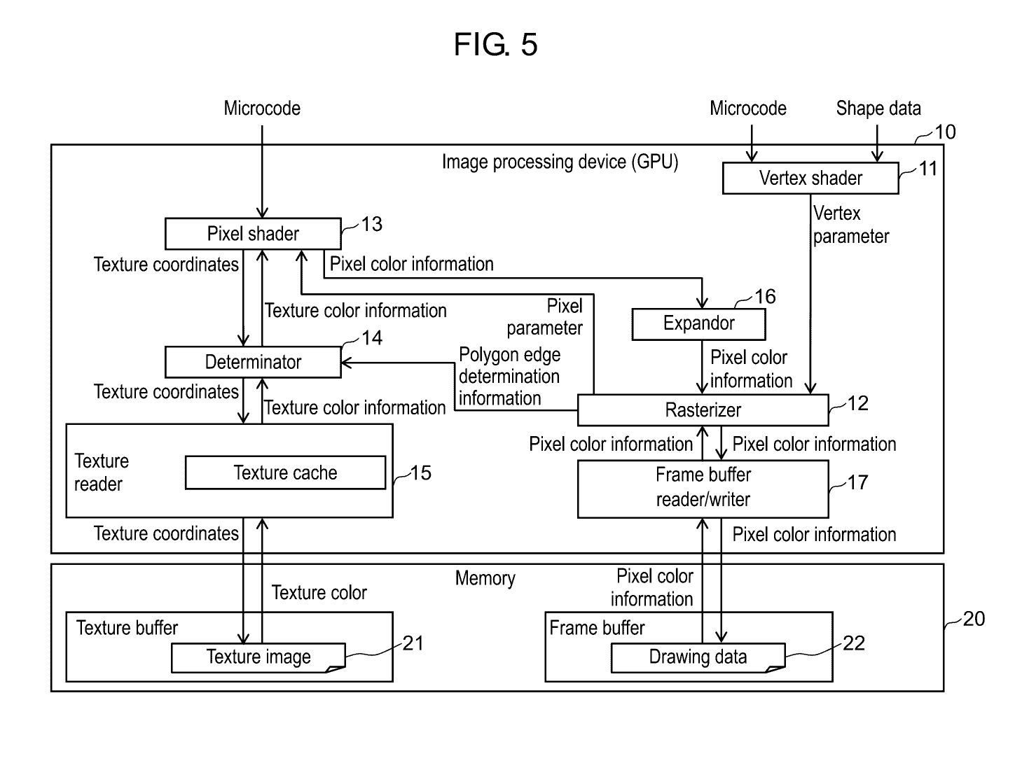

Hereinafter, a first exemplary embodiment will be described with reference to FIGS. 5 to 12B. The present exemplary embodiment describes a case where an image processing device is a GPU (Graphics Processing Unit) for generating a two-dimensional picture which is a three-dimensional shape seen from a predetermined point of sight.

Also, in the following, a case will be described where the image processing device of the present exemplary embodiment is used in a display device for displaying a picture on a liquid crystal display, an organic EL display or the like.

The image processing device of the present exemplary embodiment arranges a plurality of blocks formed by a plurality of pixels on a two-dimensional picture, determines whether or not shading processing can be performed on the plurality of blocks on a per block basis, and performs the shading processing on a per block basis for the block(s) for which the determination is made that the shading processing can be performed on a per block basis. An increase in the number of times of activation of pixel shader 13 may thereby be suppressed.

Additionally, in the following description, with respect to the original three-dimensional shape data, three or more vertices defining a polygon will be referred to as three or more second coordinate system vertices as appropriate, and the corresponding polygon will be referred to as a second coordinate system diagram as appropriate. Also, the vertices, on a two-dimensional picture, corresponding to the three or more second coordinate system vertices will be referred to as first coordinate system vertices as appropriate, a diagram, on the two-dimensional picture, corresponding to the second coordinate system diagram will be referred to as a first coordinate system diagram as appropriate, and a plurality of pixels, on the two-dimensional picture, corresponding to a plurality of second coordinate system pixels will be referred to as first coordinate system pixels as appropriate.

### 1. Configuration

A configuration of the image processing device according to the first exemplary embodiment will be described with reference to FIG. 5. Additionally, a detailed operation will be given later.

FIG. 5 is a block diagram showing an example of configuration of the image processing device according to the first exemplary embodiment.

As shown in FIG. 5, image processing device 10 includes vertex shader 11, rasterizer 12, pixel shader 13, determinator 14, texture reader 15, expandor 16, and frame buffer reader/writer 17. Also, image processing device 10 is configured to be able to perform reading processing and writing processing on memory 20.

As in the comparative example, memory 20 is a memory for storing data used for generation of a two-dimensional picture, and a generated two-dimensional picture (drawing data), and is configured by a DRAM (Dynamic Random Access Memory) or the like. Data used for generation of a two-dimensional picture includes a texture image which is used for deciding the color on the two-dimensional picture, for example. A memory area for storing a texture image will be referred to as a texture buffer, and a memory area for storing drawing data will be referred to as a frame buffer.

As in the comparative example, vertex shader 11 is an engine for receiving a microcode, shape data including three-dimensional coordinates of three or more second coordinate system vertices defining a three-dimensional shape, and (if necessary,) a coordinate transformation matrix, and for transforming the three-dimensional coordinates of the three or more second coordinate system vertices into two-dimensional coordinates of three or more first coordinate system vertices on the two picture. Vertex shader 11 outputs, to rasterizer 12, vertex parameters including the three or more two-dimensional coordinates after transformation. Additionally, in the present exemplary embodiment, the coordinates of the first coordinate system vertices after transformation by vertex shader 11 are made the two-dimensional coordinates, but depending on the intended use, the coordinates may be in dimensions higher than two (for example, three-dimensional coordinates (x, y, z), four-dimensional coordinates (x, y, z, w), or the like).

Rasterizer 12 is an example of an interpolator for performing interpolation processing. The interpolation processing is processing of generating pixel parameters including the two-dimensional coordinates of a plurality of first coordinate system pixels by using vertex parameters.

Rasterizer 12 further performs semitransparent synthesis processing by using pixel color information acquired from expandor 16.

Pixel shader 13 is an engine for deciding the color of each of the plurality of first coordinate system pixels by using the pixel parameters output from rasterizer 12. In the present exemplary embodiment, pixel shader 13 performs the shading processing on a per block basis for a block, on the two-dimensional picture, for which the determination is made by determinator 14 that the shading processing can be performed on a per block basis, and performs the shading processing on a per pixel basis for a first coordinate system pixel not included in the block. In the shading processing on a per block basis, pixel shader 13 obtains a representative color by performing arithmetic processing indicated by a microcode, by using a provisional representative color obtained from the pixel parameter or the texture image.

Determinator 14 determines, for each of a plurality of blocks obtained by dividing a first coordinate system diagram on the two-dimensional picture into a plurality of pieces, whether or not the shading processing on a per block basis can be performed. The picture is deteriorated in the case of the shading processing on a per block basis, compared to the shading processing on a per pixel basis. Accordingly, whether the shading on a per block basis can be performed or not is decided according to whether the influence on the picture is within an acceptable range or not. Determinator 14 determines that the influence is within the acceptable range in a case where the deterioration is not perceived by human eyes or where the deterioration is small. Specifically, determinator 14 determines that the influence on the two-dimensional picture is within the acceptable range, in a case where the color difference among the first coordinate system pixels in a block is within a first range.

Texture reader 15 is a memory interface for performing data reading processing on memory 20. Texture reader 15 includes a texture cache. Texture reader 15 reads a part or all of texture image 21 from memory 20, and stores the part or all of texture image 21 in the texture cache.

In the present exemplary embodiment, expandor 16 performs image enlargement processing. Expandor 16 obtains, for a block on which the shading processing on a per block basis has been performed by pixel shader 13, the color of each of a plurality of first coordinate system pixels included in the block, by using the representative color.

Frame buffer reader/writer 17 is a memory interface for performing data reading/writing processing on memory 20. Frame buffer reader/writer 17 writes drawing data 22 configured from pixel color information in the frame buffer of memory 20.

### 2. Operation

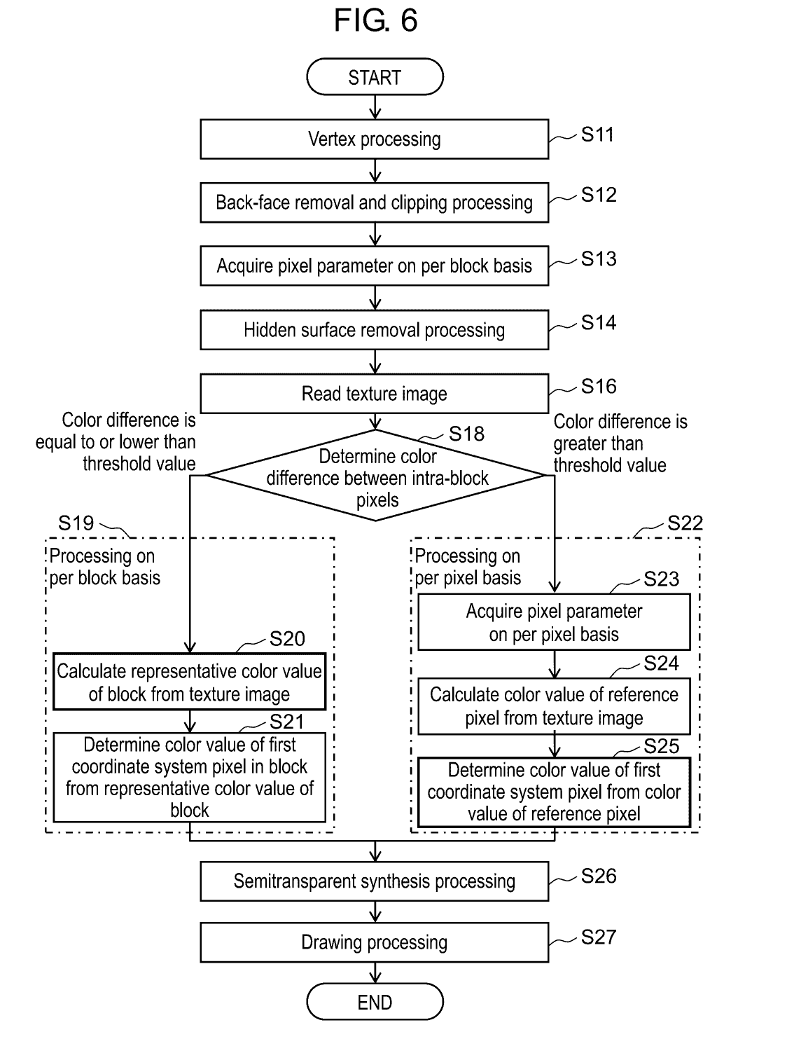

An operation (an image processing method) of image processing device 10 configured in the above manner will be described with reference to FIGS. 6 to 12B.

FIG. 6 is a flow chart showing an example of a processing procedure of an image processing method according to the first exemplary embodiment.

FIG. 6 shows a processing procedure of processing of generating a two-dimensional picture from three-dimensional shape data. Additionally, for the sake of description, FIG. 6 shows a processing procedure for a case where a texture image is read.

<2-1. Vertex Processing>

Vertex shader 11 performs vertex processing by using three-dimensional shape data (step S11).

The operation of the vertex shader according to the present exemplary embodiment is substantially the same as in the case of the comparative example.

More specifically, vertex shader 11 first receives a microcode indicating the processing content, shape data, and (if necessary,) a coordinate transformation matrix. As described above, the three-dimensional shape data is, generally, data representing a predetermined three-dimensional body by one polygon or a combination of a plurality of polygons. A polygon is triangle, for example, but it may also be a polygon such as a rectangle, a pentagon, or the like. The three-dimensional shape data includes, for each of the one or the plurality of polygons, the three-dimensional coordinates of three or more second coordinate system vertices defining the polygon.

Vertex shader 11 transforms the three-dimensional coordinates of the three or more second coordinate system vertices included in the shape data into the two-dimensional coordinates of three or more first coordinate system vertices on a two-dimensional picture seen from point-of-sight position POS.

Vertex shader 11 outputs, to rasterizer 12, vertex parameters including the two-dimensional coordinates of the three or more first coordinate system vertices after transformation. The vertex parameters may include information for deciding the color of a first coordinate system vertex, the degree of transparency, and the like. The information for deciding the color of a first coordinate system vertex is the color value of the first coordinate system vertex, or the coordinates of a pixel of a texture image to be referred to, for example.

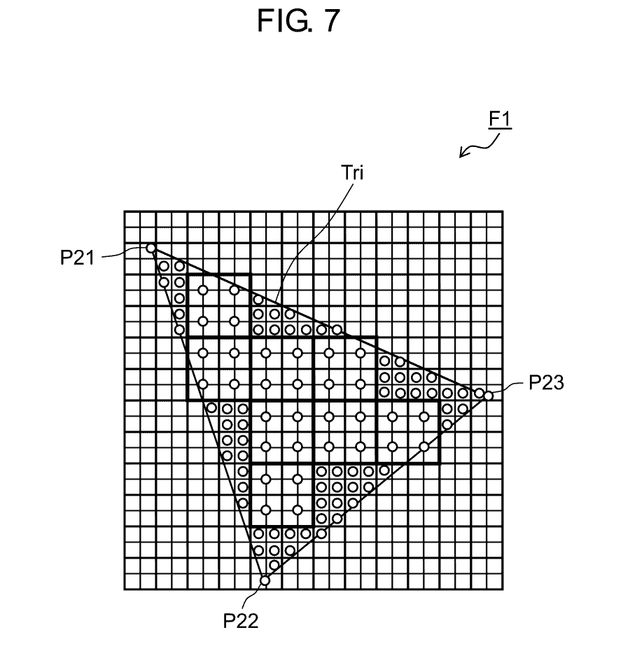

FIG. 7 is a diagram, according to the first exemplary embodiment, showing an example of triangle Tri shown in FIG. 3 on two-dimensional picture F1 when triangle Tri is seen from point-of-sight position POS.

First coordinate system vertex P21 is a point, on the two-dimensional picture, corresponding to second coordinate system vertex P11. The two-dimensional coordinates of first coordinate system vertex P21 are (x21, y21). First coordinate system vertex P22 is a point, on the two-dimensional picture, corresponding to second coordinate system vertex P12. The two-dimensional coordinates of first coordinate system vertex P22 are (x22, y22). First coordinate system vertex P23 is a point, on the two-dimensional picture, corresponding to second coordinate system vertex P13. The two-dimensional coordinates of first coordinate system vertex P23 are x23, y23).

<2-2. Back-Face Removal and Clipping Processing>

As shown in FIG. 6, after the vertex processing (step S1), rasterizer 12 performs back-face removal processing and clipping processing (step S12) as in the case of the comparative example.

The back-face removal processing is processing of removing a polygon which is at a position that cannot be seen from the point-of-sight position. The clipping processing is processing of identifying, for a polygon which is at a position at which a partial region is not seen from the point-of-sight position, a pixel which is at a position that can be seen from the point-of-sight position.

<2-3. Interpolation Processing>

Rasterizer 12 performs interpolation processing on a per block basis (step S13).

As shown in FIG. 7, in the present exemplary embodiment, a plurality of first coordinate system pixels included in a first coordinate system diagram are divided into a plurality of blocks. Each of the plurality of blocks is formed by four pixels in two rows and two columns.

In FIG. 7, thick lines indicate blocks, and extra-thick lines indicate units of expansion processing, each unit including four, i.e., 2×2, blocks. A unit of expansion processing indicates the smallest range used in expansion processing. Additionally, the unit of expansion processing and expansion processing will be described, in detail in the description of expandor 16.

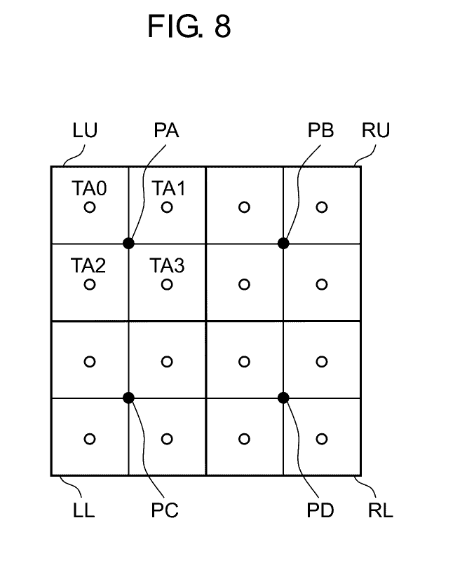

FIG. 8 is a diagram showing an example of a unit of expansion processing according to the first exemplary embodiment.

The unit of expansion processing shown in FIG. 8 includes four blocks, namely, upper left block LU, upper right block RU, lower left block LL, and lower right block RL. In FIG. 8, the representative coordinates of upper left block LU are the coordinates of PA, the representative coordinates of upper right block RU are the coordinates of PB, the representative coordinates of lower left block LL are the coordinates of PC, and the representative coordinates of lower right block RL are the coordinates of PD. Also, block LU is formed by four first coordinate system pixels TA0 to TA3.

In this case, rasterizer 12 obtains pixel parameters on a per block basis. The pixel parameters include the two-dimensional coordinates of the block, information for deciding the provisional representative color of the block, the degree of transparency, and the like. The information for deciding the provisional representative color includes position coordinates of a reference pixel (hereinafter referred to as “texture coordinates”) in a case where a texture image is used, or a color value. Rasterizer 12 outputs the pixel parameters to pixel shader 13.

<2-4. Hidden Surface Removal Processing>

As shown in FIG. 6, after the interpolation processing (step S13), rasterizer 12 performs hidden surface removal processing of removing pixel parameters of a hidden part (a part not seen from the point-of-sight position) (step S14). After the hidden surface removal processing, rasterizer 12 outputs the pixel parameters to pixel shader 13.

<2-5. Reading of Texture Image>

Next, as shown in FIGS. 5 and 6, reading of a texture image is performed (step S16).

Pixel shader 13 outputs texture coordinates to determinator 14. Determinator 14 outputs the texture coordinates to texture reader 15.

As described above, texture reader 15 is provided with a texture cache, and is capable of reading an image which is large to a certain degree from memory 20. As a method for reading a texture image by texture reader 15, there are several types including bilinear reference, point sampling, and the like.

In bilinear reference, texture reader 15 takes four pixels around the texture coordinates as reference pixels. Then, texture reader 15 outputs, to determinator 14, a weighted average value of the color values of the four reference pixels as the color value of the four reference pixels. Additionally, texture reader 15 may output four color values of the four reference pixels to determinator 14, instead of the weighted average value of the four color values of the four reference pixels.

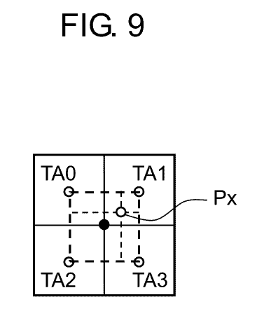

FIG. 9 is a diagram showing an example of a reference pixel in bilinear reference according to the first exemplary embodiment.

FIG. 9 shows upper left block LU in FIG. 8. In FIG. 9, Px is an example of texture coordinates. First coordinate system pixels TA0 to TA3 correspond to first coordinate system pixels TA0 to TA3 shown in FIG. 8.

As shown in FIG. 9, in bilinear reference, texture reader 15 decides four pixels whose distances from texture coordinates Px are short as the reference pixels.

In point sampling, texture reader 15 outputs, to determinator 14, the color value of one reference pixel indicated by the texture coordinates. In FIG. 9, first coordinate system pixel TA1 is taken as the reference pixel.

In a case where the color value(s) of all of one or a plurality of reference pixels is/are stored in the texture cache, texture reader 15 acquires the color value(s) of one or a plurality of reference pixels from the texture cache.

In a case where one or a plurality of reference pixels is/are not stored in the texture cache, texture reader 15 reads the region of the texture image including one or a plurality of reference pixels from memory 20 and stores the same in the texture cache, and reads the color value(s) of one or a plurality of reference pixels from the texture cache.

<2-6. Determination Processing>

Determinator 14 determines whether shading processing on a per block basis can be performed or not (step S18).

Here, determinator 14 determines that shading processing on a per block basis can be performed, in a case where all of the following three determination conditions are satisfied.

Additionally, the following three determination conditions are examples of the determination conditions, and the determination conditions may also include other determination conditions. Alternatively, the determination conditions do not have to include one or a plurality of the following three determination conditions. Alternatively, determination conditions equivalent to the following three determination conditions may be included in the determination conditions.

<2-6-1. First Determination Condition>

A first determination condition is a condition for determining fineness of a pattern of a texture image to be referred to.

Now, shading on a per block basis has a lower accuracy compared to shading on a per pixel basis, and thus deteriorates the two-dimensional picture. In the case of a block that refers to a region, of a texture image, with a fine pattern, if the shading processing is performed on a per block basis, the influence of deterioration on the picture quality is considered to be great. On the other hand, in the case of a block that refers to a region with a pattern that is uniform to a certain degree, even if shading is performed on a per block basis, it is considered that the influence of deterioration on the picture quality is small, or that there is substantially no influence.

Accordingly, determinator 14 according to the present exemplary embodiment determines the fineness of the pattern of a region of a texture image to be referred to. Then, with respect to a block for which it is determined that the pattern of the region to be referred to is uniform to a certain degree (that the pattern is not fine), determinator 14 determines that shading on a per block basis can be performed. With respect to a block for which it is determined that the pattern of the region to be referred to is fine, determinator 14 determines that shading on a per block basis cannot be performed.

In the present exemplary embodiment, determinator 14 determines the fineness of the pattern of a texture image to be referred to by using difference (amount of change) in color values CDP of four reference pixels around the texture coordinates.

Determinator 14 determines that a block in which difference in color values CDP is greater than first threshold value Tr1 (an example of a first range) is a block that refers to a region with a fine pattern, and is a block for which the shading processing on a per block basis cannot be performed.

Determinator 14 determines that a block in which difference in color values CDP is equal to or lower than first threshold value Tr1 is a block that refers to a region with a relatively uniform (rough) pattern, and is a block for which the shading processing on a per block basis can be performed.

Difference in color values CDP may be obtained by the following Equation 1.

CDP=(max(TA0r,TA1r,TA2r,TA3r)−min(TA0r,TA1T,TA2r,TA3r))+(max(TA0g,TA1g,TA2g,TA3g)−min(TA0g,TA1g,TA2g,TA3g))+(max(TA0b,TA1b,TA2b,TA3b)−min(TA0b,TA1b,TA2b,TA3b)) (Equation 1)

In Equation 1, max(a0, a1, a2, a3) indicates a maximum value among a0 to a3, and min(a0, a1, a2, a3) indicates a minimum value among a0 to a3.

Additionally, TA0r to TA3r are parameters indicating a value of an R (red) component among color values of the four reference pixels. TA0g to TA3g are parameters indicating a value of a G (green) component among color values of the four reference pixels. TA0b to TA3b are parameters indicating a value of a B (blue) component among color values of the four reference pixels.

In a case where CDP first threshold value Tr1 is true determinator 14 determines that the first determination condition is satisfied. By the determination of whether the shading processing on a per block basis can be performed or not being made based on this determination condition, the load on pixel shader 13 may be reduced while maintaining the quality of the two-dimensional picture.

Since determination of a color difference is performed for a second determination condition in the same manner as for the present determination condition, a method for deciding first threshold value Tr1 will be described in detailed together with the description of the second determination condition.

<2-6-2. Second Determination Condition>

The second determination condition is a condition for determining whether an image quality will be deteriorated or not by processing by expandor 16.

In the present exemplary embodiment, the color of each of a plurality of first coordinate system pixels forming a block is decided by expandor 16 for a block on which the shading processing on a per block basis has been performed. Thus, in the case of a block whose image quality will be deteriorated by the processing by expandor 16, the color of each of the plurality of first coordinate system pixels cannot be decided. That is, a block whose image quality will be deteriorated, by the processing by expandor 16 is a block on which the shading processing on a per block basis cannot be performed.

As will be described later, expandor 16 according to the present exemplary embodiment calculates the color of each of a plurality of first coordinate system pixels included in a block in units of expansion processing including four blocks that are adjacent to one another (adjacent blocks). In a case where the color differences among provisional representative colors of the blocks are great, if processing is collectively performed on these blocks, it is considered that the two-dimensional picture will be deteriorated and the quality will be reduced by the same reason as described in relation to the first determination condition. Accordingly, by determining the color difference for the provisional representative colors of respective blocks of four adjacent blocks, determinator 14 determines whether or not the image quality will be deteriorated by the processing by expandor 16.

In a case where it is determined that the image quality will not be deteriorated by the processing by expandor 16, determinator 14 determines that the block is a block for which the shading processing on a per block basis can be performed. In a case where it is determined that the image quality will be deteriorated by the processing by expandor 16, determinator 14 determines that the block is a block for which the shading processing on a per block basis cannot be performed.

Specifically, determinator 14 determines that; in a case where color difference CDB of the provisional representative colors of the four adjacent blocks is within a second range, the image quality will not be deteriorated by the processing by expandor 16.

Difference in color values CDB may be obtained by the following Equation 2.

CDB=(max(PAr,PBr,PCr,PDr)−min(PAr,PBr,PCr,PDr))+(max(PAg,PBg,PCg,PDg)−min(PAg,PBg,PCg,PDg))+(max(PAb,PBb,PCb,PDb)−min(PAb,PBb,PCb,PDb)) (Equation 2)

In Equation 2, PAr to PDr indicate a value of an R (red) component among color values of provisional representative coordinates of the blocks. PAg to PDg indicate a value of a G (green) component among color values of provisional representative coordinates of the blocks. PAb to PDb indicate a value of a B (blue) component among color values of provisional representative coordinates of the blocks.

In a case where CDB≦second threshold value Tr2 (an example of the second range) is true, determinator 14 determines that the second determination condition is satisfied.

<Method for Deciding First Threshold Value and Second Threshold Value>

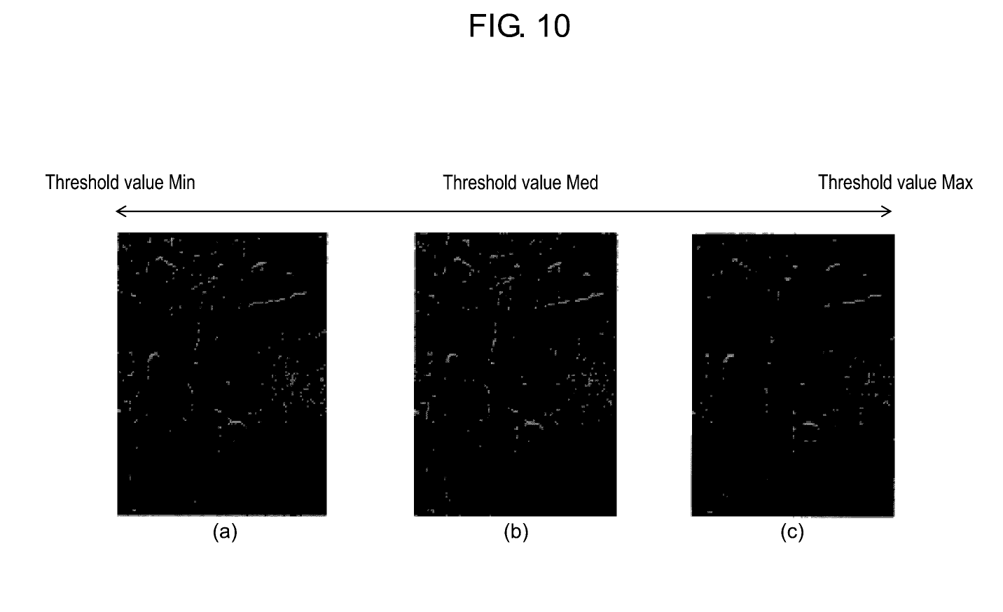

FIG. 10 is a diagram, according to the first exemplary embodiment, showing examples of two-dimensional pictures where first threshold value Tr1 and second threshold value Tr2 are changed. In FIG. 10, first threshold value Tr1 and second threshold value Tr2 are set to have the same value for the sake of convenient illustration.

Here, in a case where each of the R component, the G component, and the B component of the color values is expressed in eight bits, values between 0 to 765 may be used for the values of first threshold value Tr1 and second threshold value Tr2. In this case, in FIG. 10, threshold value Min takes a minimum value 0 (zero), threshold value Med takes a median value 127, and threshold value Max takes a maximum value 765.

In FIG. 10, (a) shows an example of the two-dimensional picture where threshold value Min is used as first threshold value Tr1 and second threshold value Tr2. In FIG. 10, (b) shows an example of the two-dimensional picture where threshold value Med is used as first threshold value Tr1 and second threshold value Tr2. In FIG. 10, (c) shows an example of the two-dimensional picture where threshold value Max is used as first threshold value Tr1 and second threshold value Tr2.

In a case where threshold value Min is used as first threshold value Tr1 and second threshold value Tr2, the number of blocks for which the determination is made that the shading processing can be performed on a per block basis becomes the smallest. In a case where threshold value Max is used as first threshold value Tr1 and second threshold value Tr2, the number of blocks for which the determination is made that the shading processing can be performed on a per block basis becomes the greatest.

Accordingly, as shown in FIG. 10, reduction in the quality of the two-dimensional picture is suppressed to the minimum in the case where threshold value Min is used as first threshold value Tr1 and second threshold value Tr2. Reduction in the quality of the two-dimensional picture is relatively great in the case where threshold value Max is used as first threshold value Tr1 and second threshold value Tr2.

According to the above, an appropriate value is preferably decided for first threshold value Tr1 and second threshold value Tr2 by taking into account the size of the two-dimensional picture, the size and accuracy of the display device for displaying the two-dimensional picture, properties of the two-dimensional picture (for example, whether the picture requires fine depiction such as in the case of a movie), the processing speed required to generate the two-dimensional picture at image processing device 10, and the like. Additionally, first threshold value Tr1 and second threshold value Tr2 may be of the same value, or of different values.

<2-6-3. Third Determination Condition>

A third condition is a condition for determining whether or not a block includes a polygon edge indicating a boundary of a polygon.

During drawing of a polygon, the color value of outside the polygon is not known. Accordingly, if processing is performed on a per block basis for pixels in a block including a polygon edge, the two-dimensional picture is possibly deteriorated, and the quality is possibly reduced. Accordingly, determinator 14 determines, with respect to pixels in a block including a polygon edge, that the block is a block for which the shading processing on a per block basis cannot be performed.

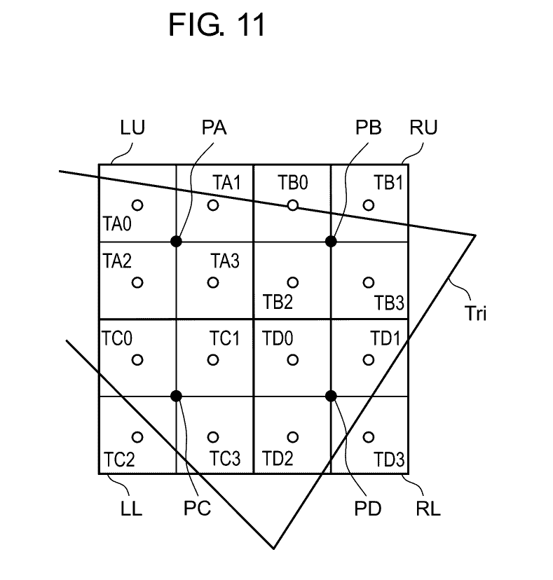

FIG. 11 is a diagram, according to the first exemplary embodiment, for illustrating determination of whether a polygon edge is included or not.

In the present exemplary embodiment, determinator 14 acquires information (polygon edge determination information) that is necessary for determining whether a polygon edge is included or not from rasterizer 12. Determinator 14 performs the determination of whether a polygon edge is included or not in units of expansion processing including one or a plurality of blocks. In a case where representative coordinates of all the blocks included in a unit of expansion processing are located inside a polygon, determinator 14 determines that all the blocks included in the unit of expansion processing are blocks not including a polygon edge.

In this case, the representative coordinates of a block are center coordinates of the block. Alternatively, the representative coordinates of a block may be other coordinates.

In the case of FIG. 11, all of representative coordinates PA of block LU, representative coordinates PB of block RU, representative coordinates PC of block LL, and representative coordinates PD of block RL are located within triangle Tri. Accordingly, it is determined that blocks LU, RU, LL, and RI, are blocks not including a polygon edge.

<2-7. Decision of Color on Per Block Basis>

As shown in FIG. 6, image processing device 10 performs processing for deciding the color of each of a plurality of first coordinate system pixels on a per block basis for a block for which the determination is made that the shading can be performed on a per block basis. (step S19).

Pixel shader 13 calculates the representative color of a block by performing the shading processing on a per block basis (step S20).

In the shading processing on a per block basis, pixel shader 13 calculates the representative color of a block by calculating the provisional representative color at representative coordinates of the block and by performing the shading processing by using the provisional representative color.

As described above, in this case, the representative coordinates are the center coordinates of a block. The provisional representative color is, in this case, the color value obtained from the reference pixel of a texture image, and is used for the shading processing.

Pixel shader 13 obtains the provisional, representative color of a block from the color values of a plurality of reference pixels corresponding to a plurality of first coordinate system pixels forming the block. The provisional representative color is the color value of a pixel at texture coordinates corresponding to the representative coordinates of the block, for example. Additionally, in a case where determinator 14 has performed bilinear reference, in step S18, by using the representative coordinates of the block and has acquired the weighted average value, the weighted average value may be used as the provisional representative color.

Alternatively, pixel shader 13 may calculate the provisional representative color by using the color values of a plurality of reference pixels used by determinator 14 in the determination processing in step S18. Additionally, pixel shader 13 may newly acquire the color values of a plurality of reference pixels from the texture cache of texture reader 15, and calculate the provisional representative color by using the acquired color values of the plurality of reference pixels. In this case, the color value of the provisional representative color may be a median value, an average value, a weighted average value, or the like.

Pixel shader 13 decides the representative color of a block by performing the shading processing with the provisional representative color or the like as a parameter. The shading processing is substantially the same as the shading processing of the comparative example.

Expandor 16 decides, by using the representative color at the representative coordinates of a block calculated by pixel shader 13, the color value of each of a plurality of first coordinate system pixels included in the block (step S21).

In the present exemplary embodiment, expandor 16 takes four, i.e., 2×2, blocks as one unit of expansion processing, and decides the color value of each of a plurality of first coordinate system pixels in the unit of expansion processing. Specifically, expandor 16 assumes that an image of 2×2 pixels formed by four representative colors of four blocks is an image whose accuracy is one half, and performs enlargement processing of enlarging the image into an image of 4×4 pixels.

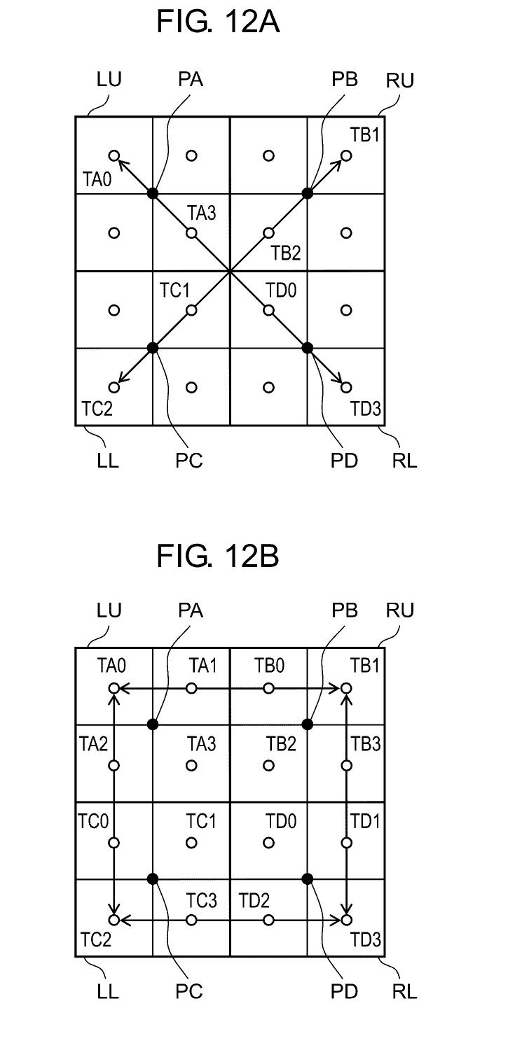

FIGS. 12A and 12B are diagrams for illustrating an example of the enlargement processing according to the first exemplary embodiment.

First, as shown in FIG. 12A, expandor 16 calculates, by using the color values of PA and PD, the color value of each of first coordinate system pixels TA0, TA3, TD0, and TD3, which are present on a line connecting PA and PD. First coordinate system pixels TA3 and TD0 are present between (on the inside of) PA and PD, and thus their color values may be calculated by interpolation. First coordinate system pixels TA0 and TD3 are present at other than between PA and PD, and thus their color values may be calculated by extrapolation.

Specifically, the color values of respective first coordinate system pixels TA0, TA3, TD0, and TD3 are obtained by the following Equations 3 to 6, by using the representative colors (PA, PB, PC, and PD) of four blocks LU, RU, LL, and RL.

TA0=(5/4)PA+(−1/4)PD (Equation 3)

TA3=(3/4)PA+(1/4)PD (Equation 4)

TD0=(1/4)PA+(3/4)PD (Equation 5)

TD3=(−1/4)PA+(5/4)PD (Equation 6)

In the same manner, expandor 16 calculates the color value of each of first coordinate system pixels TB1, TB2, TC1, and TC2, which are present on a line connecting PB and PC, by using the color values of PB and PC.

Next, expandor 16 calculates the color value of each of remaining first coordinate system pixels TA1, TA2, TB0, TB3, TC0, TC3, TD1, and TD2 in the manner shown in FIG. 12B.

First coordinate system pixels TA1 and TB0 are present at positions between first coordinate system pixels TA0 and TB1 whose color values have been calculated by the processing shown in FIG. 12A, on the line connecting first coordinate system pixels TA0 and TB1. Accordingly, expandor 16 may calculate the color value of each of first coordinate system pixels TA1 and TB0 by interpolation and by using the color values of first coordinate system pixels TA0 and TB1.

Specifically, the color values of first coordinate system pixels TA1 and TB0 may be obtained by the following Equations 7 and 8.

TA1=(2/3)TA0+(1/3)TB1 (Equation 7)

TB0=(1/3)TA0+(2/3)TB1 (Equation 8)

Expandor 16 may, in the same manner, calculate the color value of each of first coordinate system pixels TA2 and TC0 by interpolation and by using the color values of first coordinate system pixels TA0 and TC2. Expandor 16 may calculate the color value of each of first coordinate system pixels TB3 and TD1 by interpolation and by using the color values of first coordinate system pixels TB1 and TD3. Expandor 16 may calculate the color value of each of first coordinate system pixels TC3 and TD2 by interpolation and by using the color values of first coordinate system pixels TC2 and TD3.

Additionally, in the case of obtaining the color value of a first coordinate system pixel by extrapolation, expandor 16 possibly calculates a value outside the range of color values in some cases. In this case, expandor 16 may clip the color value by the maximum value or the minimum value.

In this manner, image processing device 10 may decide the color of each of a plurality of first coordinate system pixels included in a block for which it is determined by processing of steps S20 and S21 that shading on a per block basis can be performed.

<2-8. Decision of Color on Per Pixel Basis>

As shown in FIG. 6, image processing device 10 performs processing for deciding the color of each of a plurality of first coordinate system pixels on a per pixel basis for a block for which it is determined that shading on a per block basis cannot be performed (step S22). This processing is substantially the same as the processing of the comparative example.

Rasterizer 12 obtains pixel parameters on a per pixel basis. The pixel parameters include the two-dimensional coordinates, information for deciding the color, the degree of transparency, and the like. Information for deciding the color includes the texture coordinates or the color value. Rasterizer 12 outputs the pixel parameters to pixel shader 13 (step S23).

Pixel shader 13 acquires, through determinator 14, the color value of the reference pixel indicated by the texture coordinates of each pixel (step S24).

Pixel shader 13 calculates the color value of each of the plurality of first coordinate system pixels by performing, on each of the plurality of first coordinate system pixels, the shading processing by using the color value of the reference pixel (step S25).

In this manner, image processing device 10 may decide the color of each of a plurality of first coordinate system pixels included in a block for which it is determined that shading on a per block basis cannot be performed, by performing processing of steps S23 to S25.

<2-9. Post-Processing>

Rasterizer 12 performs semitransparent synthesis processing by using the color value, of each of a plurality of first coordinate system pixels, which has been decided by pixel shader 13 and expandor 16 in step S19, the color value, of each of a plurality of first coordinate system pixels, which has been decided by pixel shader 13 in step S22, and the degree of transparency included in the pixel parameters (step S26).

The semitransparent synthesis processing is processing of making the first coordinate system diagram transparent according to the degree of transparency. The first coordinate system diagram is a polygon whose color has been decided by performance of step S19 or step S22. Specifically, rasterizer 12 synthesizes, in the semitransparent synthesis processing in step S26, the first coordinate system diagram and drawing data drawn up to then, which has been read by frame buffer reader/writer 17, according to the ratio according to the degree of transparency.

Rasterizer 12 performs drawing processing of writing pixel color information (drawing data) after the semitransparent synthesis processing in the frame buffer of memory 20 by frame buffer reader/writer 17 (step S27).

### 3. Effects, Etc.

As described above, image processing device 10 according to the present exemplary embodiment determines whether or not shading processing on a per block basis can be performed, and performs the shading processing on a per block basis for a block on which the shading processing on a per block basis can be performed.

As described above, the shading processing by pixel shader 13 includes relatively complex processing indicated by a microcode, and high-load processing such as texture reference, or the like. Image processing device 10 according to the present exemplary embodiment performs the shading processing on a per block basis for a part of a plurality of first coordinate system pixels. Accordingly, image processing device 10 may reduce the number of times of the shading processing compared to a case where the shading processing on a per pixel basis is performed on all of a plurality of first coordinate system pixels.

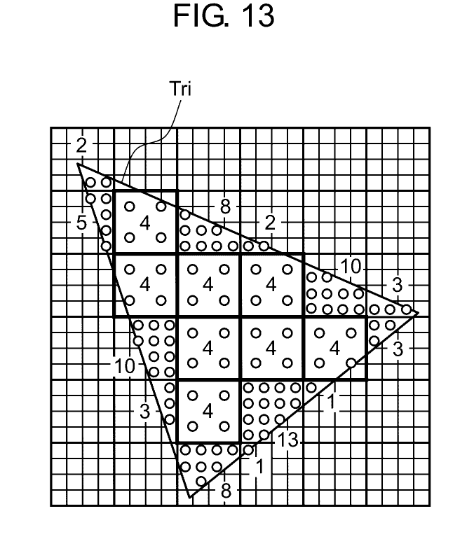

FIG. 13 is a diagram showing an example of the number of times of shading processing according to the first exemplary embodiment.

As shown by the example in FIG. 13, according to the present exemplary embodiment, the shading processing is performed (4×8+69=) 101 times for triangle Tri. On the other hand, in a case where the shading processing is to be performed for all the first coordinate system pixels, since triangle Tri is formed by 193 pixels, as shown in FIG. 4, the shading processing is performed 193 times.

As illustrated in FIG. 13, with image processing device 10 according to the present exemplary embodiment, since the number of times of performance of the shading processing is reduced, it can be seen that the processing load is reduced.

Additionally, in image processing device 10, so-called diagram enlargement processing by expandor 16 becomes necessary at the time of performance of the shading processing on a per block basis. However, compared to the load of the shading processing, the load of the enlargement processing by expandor 16 is considerably small. Thus, with image processing device 10, even if the enlargement processing by expandor 16 is added, since the number of times of the shading processing is reduced, an effect of reduction of the processing load may be expected.

Furthermore, with image processing device 10 according to the present exemplary embodiment, the number of times of the shading processing may be reduced, and thus the processing speed may be increased. For example, with image processing device 10 according to the present exemplary embodiment, in case that the shading processing on a per pixel basis is performed for 20% of the first coordinate system pixels among one frame, and the shading processing on a per block basis is performed for 80% of the first coordinate system pixels, the processing time is 0.25 times×80%+1 time×20%=0.4 times (that is, the processing speed becomes 2.5 times).

Additionally, the enlargement processing by expandor 16 may be performed in parallel with the shading processing, and also the processing time of the enlargement processing is significantly smaller than the processing time of the shading processing, and is thus not taken into account in this case.

Moreover, the effect of reduction in the processing time at image processing device 10 depends on the number of blocks on which the shading processing on a per block basis can be performed. Accordingly, the effect of reduction in the processing time at image processing device 10 changes according to the fineness of the pattern of a texture image to be referred to, the values of first threshold value Tri and second threshold value Tr2 used in step S18, and the like.

### 4. Proof of Infringement

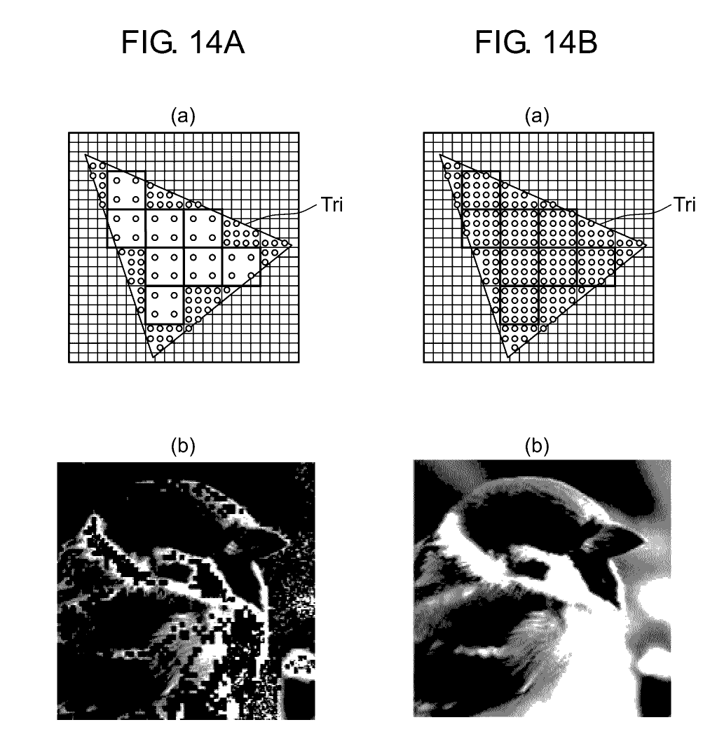

FIGS. 14A and 14B are diagrams for illustrating the difference between a two-dimensional picture generated by using image processing device 10 of the first exemplary embodiment and a two-dimensional picture generated by using the image processing device of the comparative example.

In FIGS. 14A and 14B, a case is assumed for the sake of description where a texture image is pasted inside rectangles at the same magnification. Also, FIG. 14A shows spots, in a two-dimensional picture generated by using image processing device 10 of the present exemplary embodiment, different from the comparative example. FIG. 14B shows an original texture image, that is, a two-dimensional picture generated in the comparative example.

As can be seen from FIGS. 14A and 14B, the differences in the color values are present in the manner of blocks. This is because shading processing on a per block basis is performed by image processing device 10. Therefore, in a case where the differences in the color values are present in the manner of blocks, it may be assumed that a two-dimensional picture is generated by using image processing device 10 of the present application.

### 5. First Modified Example

### Case Where Reading of Texture Image is Not Performed

A case where reading of a texture image is indicated by a microcode is described with reference to FIG. 6, but the present disclosure is not limited to such a case. In a case where reading of a texture image is not indicated, reading of a texture image by texture reader 15 (step S16) is not performed. Also, acquisition of the color value from the pixel parameter is performed in step S22 instead of calculation of the position of a reference image in a texture image on a per pixel basis (step S23) and acquisition of the color value of a reference pixel (step S24). In step S25, the color value of the first coordinate system pixel is decided based on the color value of the pixel parameter.

### 6. Second Modified Example

### Another Example of Determination of Polygon Edge

According to the first exemplary embodiment and the first modified example described above, in the determination of whether a polygon edge is included in a block or not (the third determination condition) in the determination processing in step S16 shown in FIG. 6, it is determined that a polygon edge is not included, in a case where the representative coordinates of all the blocks included in a unit of expansion processing are located inside the polygon. However, the present disclosure is not limited to such a case.

For example, in a case where the representative coordinates of the blocks for which the expansion processing can be performed, among a plurality of blocks included in a unit of expansion processing, are located inside a polygon, determinator 14 may determine, for the blocks whose representative coordinates are located inside the polygon, that the blocks do not include a polygon edge. In the case of the first exemplary embodiment described above, in case that the representative coordinates of three blocks, among four blocks included in a unit of expansion processing, are located inside the polygon, determinator 14 may determine that the three blocks are blocks not including a polygon edge.

In this case, expandor 16 performs the expansion processing by using the representative colors of the blocks, in a unit of expansion processing, which are determined to not include a polygon edge.

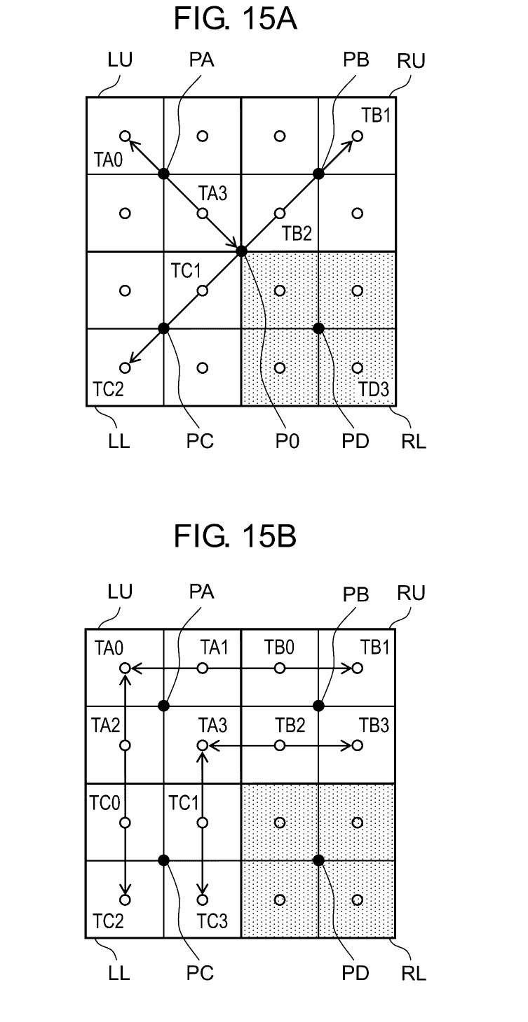

FIGS. 15A and 15B are diagrams for illustrating an example of enlargement processing according to a second modified example.

In FIGS. 15A and 15B, blocks LU, RU, and LL are blocks which are determined to not include a polygon edge, and block RL is a block which is determined to include a polygon edge.

As shown in FIG. 15A, first, expandor 16 calculates the color values of first coordinate system pixels TB1, TB2, TC1, and TC2, which are present on a line connecting PB and PC, by using the color values of PB and PC. Expandor 16 may calculate the color values of these first coordinate system pixels by interpolation, in the same manner as in the first exemplary embodiment.

Next, since the reliability of the color value of PD is low, expandor 16 obtains the color value of intersection point P0 of a line connecting PA and PD and the line connecting PB and PC. The color value of intersection point P0 may be obtained by the following Equation 9.

P0=(1/2)PB+(1/2)PC (Equation 9)

Next, expandor 16 calculates, by using the color values of PA and P0, the color value of first coordinate system pixel. TA0 by using extrapolation, and the color value of first coordinate system pixel TA3 by interpolation, respectively. The color values of first coordinate system pixels TA0 and TA3 may be obtained by the following Equations 10 and 11.

TA0=(3/2)PA+(−1/2)P0 (Equation 10)

TA3=(1/2)PA+(1/2)P0 (Equation 11)

Next, expandor 16 obtains the color values of first coordinate system pixels TA2, TC0, TA1, and TB0 by the same procedure as in the first exemplary embodiment.

Furthermore, expandor 16 obtains the color value of first coordinate system pixel TC3 by extrapolation and by using the color values of first coordinate system pixels TC1 and TA3. In the same manner, expandor 16 obtains the color value of first coordinate system pixel TB3 by extrapolation and by using the color values of first coordinate system pixels TB2 and TA3.

Image processing device 10 may thus calculate the color value of each of a plurality of first coordinate system pixels for three blocks LU, RU, and LL which are determined not to include a polygon edge.

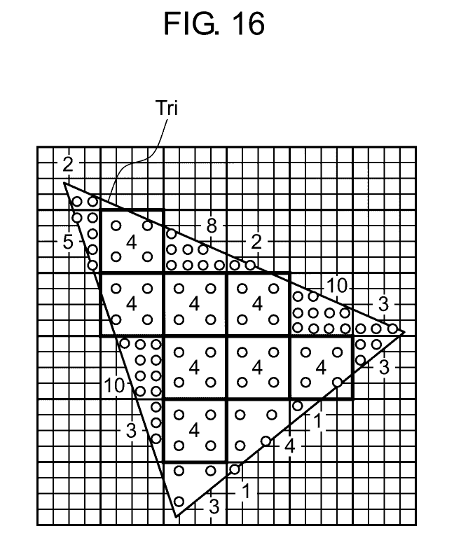

FIG. 16 is a diagram showing an example of a number of times of shading processing according to the second modified example.

As shown by the example in FIG. 16, according to the present modified example, the number of times of shading processing for triangle Tri is (4×9+3+48=) 87 times.

Compared to the first exemplary embodiment described above, the present modified example is particularly advantageous in a case where the proportion of blocks including a polygon edge is high.

### Other Exemplary Embodiments

The first exemplary embodiment, and the first and the second modified examples have been described above as examples of the technology of the present disclosure. The appended drawings and the detailed description are provided to this end.

Therefore, the structural elements shown in the appended drawings and described in the detailed description may include not only structural elements that are essential for solving the problem but also other structural elements that are not essential for solving the problem in order to exemplify the technology. Hence, it should not be certified that those non-essential elements are essential immediately, with that those non-essential elements are described in the accompanying drawings and the detailed description.

For example, in the first exemplary embodiment (or in the first or the second modified example), determinator 14 may be provided in texture reader 15 or in pixel shader 13. Furthermore, expandor 16 may be provided in rasterizer 12 or in pixel shader 13. Moreover, in the first exemplary embodiment (or in the first or the second modified example), a memory mounted in image processing device 10 may be used instead of external memory 20.

Furthermore, typically, image processing device 10 is configured by hardware, but it may alternatively be configured by software. In a case where image processing device 10 is configured by software, image processing device 10 is realized by a computer executing a program for executing each procedure of the image processing method according to the first exemplary embodiment (or the first or the second modified example).

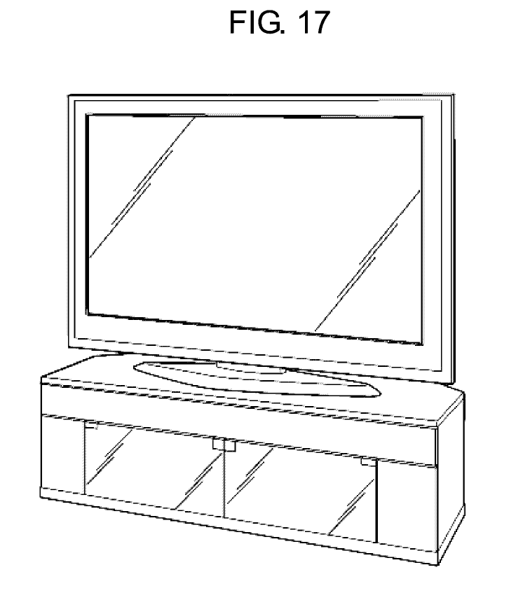

In the first exemplary embodiment, and the first and the second modified examples described above, a case has been described where image processing device 10 is applied to a display device. However, the present disclosure is not limited to such a case. FIG. 17 is a diagram showing an example of the display device. Image processing device 10 may be used for appliances that handle drawing of polygons in general, such as a game console, a CAD (Computer Aided Design), PC (Personal Computer), and the like.

Also, since the above-described exemplary embodiments are for exemplifying the technology in the present disclosure, the exemplary embodiments may be subjected to various kinds of modification, substitution, addition, omission, or the like within the scope of the claims and their equivalents.

The present disclosure may be applied to an image processing device, an image processing method, and a display device which are for performing shading processing in three-dimensional graphics. Specifically, the present disclosure may be applied to a game console, a CAD used in designing a building or a vehicle, and the like.

What is claimed is:

1. An image processing device comprising:
a pixel shader for deciding a color of each of a plurality of pixels forming a diagram that is defined by three or more first coordinate system vertices on a two-dimensional picture, and
a determinator for determining whether or not shading processing on a per block basis is able to be performed, for a block including some of the plurality of pixels,
wherein the pixel shader decides,
in a case where the determinator determines that the shading processing on a per block basis is able to be performed, a representative color of the block by performing the shading processing on a per block basis on the block, and
in a case where the determinator determines that the shading processing on a per block basis is not able to be performed, a color of each of the plurality of pixels by performing shading processing on a per pixel basis on the each of the plurality of pixels.

2. The image processing device according to claim 1, further comprising an expandor for deciding, after the representative color of the block is decided by the pixel shader, colors of the plurality of pixels by using the representative color of the block.

3. The image processing device according to claim 2, wherein
the determinator acquires a texture image, and in a case where a difference in color among a plurality of reference images on the texture image corresponding to representative coordinates of the block is within a first range, the determinator determines that the shading processing on a per block basis is able to be performed.

4. The image processing device according to claim 2, wherein
in a case where a difference between a representative color of an adjacent block that is adjacent to the block and the representative color of the block is within a second range, the determinator determines that the shading processing on a per block basis is able to be performed.

5. The image processing device according to claim 4, wherein
the expandor decides colors of pixels, among the plurality of pixels, included in the block and the adjacent block by performing enlargement processing on an image formed by the representative color of the block and the representative color of the adjacent block.

6. The image processing device according to claim 2, wherein
in a case where the block does not include a polygon edge, the determinator determines that the shading processing on a per block basis is able to be performed.

7. The image processing device according to claim 2, wherein
the image processing device is a device for generating the two-dimensional picture that is a three-dimensional shape seen from a predetermined point of sight,
the image processing device further comprises:
a vertex shader for transforming three-dimensional coordinates of three or more second coordinate system vertices defining the three-dimensional shape into coordinates of the three or more first coordinate system vertices on the two-dimensional picture, and for generating a vertex parameter including the coordinates of the three or more first coordinate system vertices; and
an interpolator for generating a pixel parameter including two-dimensional coordinates of the plurality of pixels by using the vertex parameter, and
the determinator divides a region including the diagram on the two-dimensional picture into a plurality of the blocks, and determines, for each of the plurality of the blocks, whether or not the shading processing on a per block basis is able to be performed.

8. An image processing method for deciding a color of each of a plurality of pixels forming a diagram that is defined by three or more first coordinate system vertices on a two-dimensional picture, the method comprising:
determining whether or not shading processing on a per block basis is able to be performed, for a block including some of the plurality of pixels;
deciding, in a case where it is determined that the shading processing on a per block basis is able to be performed, a representative color of the block by performing the shading processing on a per block basis on the block; and
deciding, in a case where it is determined that the shading processing on a per block basis is not able to be performed, a color of each of the plurality of pixels by performing shading processing on a per pixel basis on the each of the plurality of pixels.

9. A display device comprising the image processing device according to claim 1.
